(19) United States
(12) Patent Application Publication
(10) Pub. No.: US 2010/0231582 A1
(43) Pub. Date: Sep. 16, 2010

(54) METHOD AND SYSTEM FOR DISTRIBUTING ANIMATION SEQUENCES OF 3D OBJECTS

(75) Inventors: CEMIL TURUN, Istanbul (TR); S. Eray Berger, Istanbul (TR); Engin Erenturk, Istanbul (TR)

Correspondence Address: PERKINS COIE LLP, P.O. BOX 1208, SEATTLE, WA, 98111-1208, US

(73) Assignee: Yogurt Bilgi Teknolojileri A.S.

(21) Appl. No.: 12/401,562

(22) Filed: Mar. 10, 2009

(51) Int. Cl. G06T 15/00

(52) U.S. Cl. 345/419

(57) ABSTRACT

A method and system for displaying 3D objects. The method includes creating a 3D object for rendering. The method includes exporting the 3D object as a mesh object, a skeleton, and an animation description. The method includes distributing the mesh object, the skeleton, and the animation description as at least two separate files. The method includes combining the mesh object, the skeleton, and the animation description at a user workstation for rendering a sequence defined by the 3D object.

### BACKGROUND

3D rendering is a computer graphics process for converting 3D objects into 2D images for display on a 2D surface, such as a computer monitor. A 3D object can include animation descriptions describing movements and changes in the 3D object over time. A 3D object can also include a mesh object or unstructured grid, which is a collection of vertices, edges and faces that define the shape of a polyhedral object in 3D computer graphics and solid modelling. The faces include simple convex polygons, general concave polygons, or polygons with holes.

A 3D object can also include a skeleton. Skeletons in a 3D character animation have a direct correlation to a human skeleton: they consist of articulated joints and bones, and they can be used as a controlling mechanism to deform attached mesh data via “skinning.” The skeleton is actually just composed of “null nodes” in 3D space (or “dummy nodes” or “grouping nodes” as they are also often called). Parenting the null nodes together creates an explicit hierarchy, and the transformations on the null nodes define the rotation and offset of each null node from its parent null node. The location of each null node coincides with a “joint” and the distance between two child-parent null nodes defines the length of the bone.

Some 3D programs are “joint based” and others “bones based.” Joint based systems means that the bone is visualized implicitly between two joint nodes (two null nodes). Thus, you always need at least two joints to define a bone. Bone based systems means that a bone is visualized based on a starting location, direction and bone length (a child joint node is not necessary in these programs for a bone to become visible).

The three parts of a 3D object: the animation descriptions, the mesh object, and the skeleton describe the 3D object for rendering. For example, the 3D object can be an avatar or another entity in a virtual environment. Rendering the 3D object produces a sequence of 2D images, which show an animation of the 3D object when displayed sequentially.

A virtual world is a computer-based simulated environment intended for its users to inhabit and interact via avatars. These avatars can be user-specified 3D objects that represent a user in the virtual world.

A user's workstation accesses a computer-simulated world and presents perceptual stimuli (for example, visual graphics and audible sound effects) to the user, who in turn can manipulate elements of the virtual world. Communications between users include text, graphical icons, visual gesture, and sound. A type of virtual world is the massively multiplayer online games (MMOG) commonly depict a world very similar to the real world, with real world rules and real-time actions, and communication. Communication is usually textual, with real-time voice communication using VOIP also possible.

Many objects in the virtual world, such as avatars, can be 3D objects that need to be displayed on a user's workstation. Unfortunately, workstation performance can be limited by workstation resources and available bandwidth.

Current applications such as Adobe Flash allow rendering 3D data into animation sequences. For example, such functionality can be provided via Action Script code. The render is generated into the computer's volatile memory (RAM) for immediate display or later storage into non-volatile memory. Current approaches to distributing an animation sequence include distributing the rendered sequence as an inseparable package. This reduces display flexibility at a user workstation.

Thus, there is a need to improve distribution of animation sequences by increasing distribution flexibility.

### BRIEF DESCRIPTION OF DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates an example system for improved rendering of 3D objects.

FIG. 2 illustrates an example workstation for displaying 3D objects to a user.

FIG. 3 illustrates an example server for distributing 3D objects over a network.

FIG. 4A illustrates an example 3D object rendered into an avatar in a virtual world.

FIG. 4B illustrates an example data structure for storing a 3D object.

FIG. 5A illustrates an example procedure to create a 3D object.

FIG. 5B illustrates an example procedure to display a 3D object at a terminal.

### DETAILED DESCRIPTION

A method of distributing animation sequences for playback on a user's workstation. A sequence is rendered from a mesh object, a skeleton, and an animation. The components are created by a designer and distributed from a server over a network. A user can download and cache the mesh object and skeleton at the workstation. The sequence is then generated from a streaming animation received from the server. By caching the mesh object and skeleton, bandwidth requirements are reduced for multiple sequences utilizing the same characters, such as periodic episodes of a cartoon.

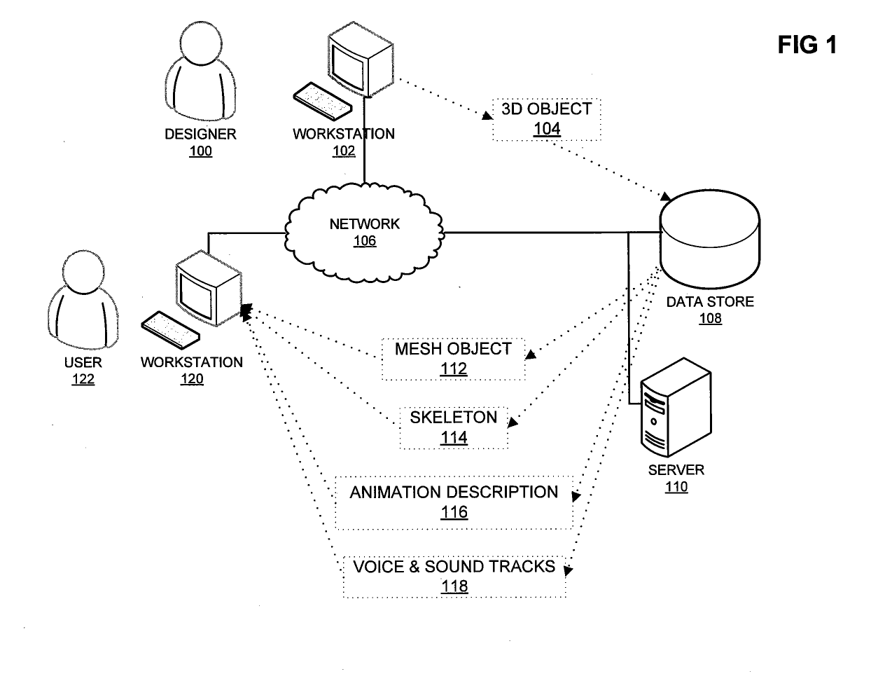

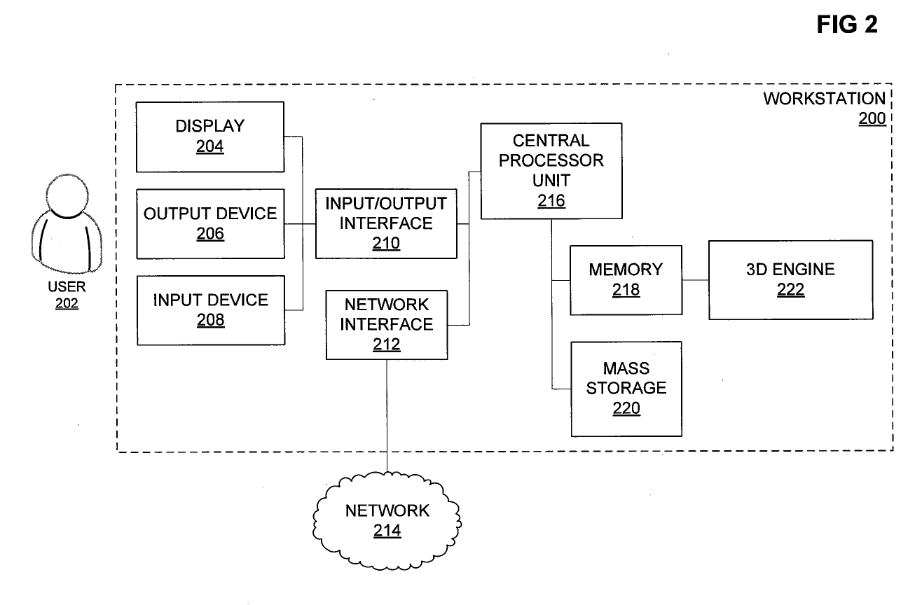

FIG. 1 illustrates an example system for improved rendering of 3D objects. A designer 100 can use a user interface provided by a workstation 102 to create a 3D object 104. The workstation 102 can be as illustrated in FIG. 2.

The 3D object 104 can include a mesh object, a skeleton, and an animation description defining a sequence which is rendered. In one embodiment, the 3D object components can be exported by the workstation into a first file containing the mesh object and the skeleton, and a second file containing the animation description.

The 3D object 104 can be transmitted over a network 106 to a data store 108. For example, the network 106 can be any network configured to transmit and forward digital data. For example, the data store 108 can be computer-readable medium for storing data such as a disk drive, or a system for storing data such as a data base.

The data store 108 can be configured to serve the 3D object components responsive to requests received over the network 106. For example, the network 106 can be the Internet, and the data store 108 provides the 3D object components to users over the Internet.

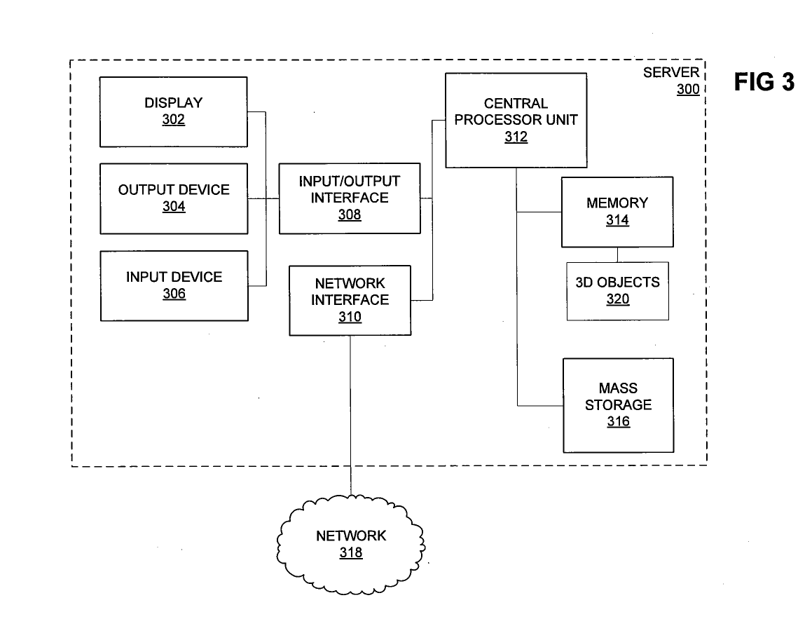

A server 110 can be as illustrated in FIG. 3. The server 110 can be in communications with the network 106. In one embodiment, the server interfaces between the network 106 and the data store 108.

It will be appreciated that any number of servers can exist in the system, for example, distributed geographically to improve performance and redundancy.

As discussed above, the 3D object 104 can be stored as a mesh object 112, a skeleton 114, and an animation description 116. The 3D object components can be stored in one or more files. Responsive to a user request, the 3D object components are transmitted to a workstation 120 over the network 106. In additional, a voice track and a sound track 118 can be transmitted to the workstation 120.

The workstation 120 can render the 3D object components into a sequence for display to a user 122. In addition, the workstation 120 can play back the voice track and the sound track 118 substantially simultaneously with displaying the rendering, providing an audio accompaniment to the playback.

In the system above, in operation, the animation description 116 can describe a particular animation sequence of a specific mesh object and a skeleton. By transmitting a replacement animation description, the workstation 120 can render a replacement sequence. For example, the user 122 can access one or more cartoon episodes. Each character in the cartoon can be associated with a mesh object and a skeleton. Each episode can be associated with an animation description and a voice track for each cartoon character. Each episode can also be associated with a sound track.

This system allows a one-time download of the necessary mesh objects and skeletons, which are cached at the workstation 120. Subsequent episodes can be displayed by simply downloading replacement animation descriptions, voice tracks, and sound tracks. Network resource requirements of the network 106 are thus decreased.

Subscription Services

The cartoon episodes can be distributed to one or more subscribers. The user 122 can pay valuable consideration to become a subscriber, and receive replacement animation descriptions, voice tracks, and sound tracks as they are created. In an alternative embodiment, the replacement animation descriptions, voice tracks, and sound tracks can be streamed from the data store 108. This efficiently distributes animated content to subscribers, when the animated content is periodically updated.

In one embodiment, additional mesh objects and skeletons corresponding to newly introduced cartoon characters can be distributed to the subscribers. As discussed, the workstation 120 can cache the newly received mesh objects and skeletons. Furthermore, the server 110 can distributed updated mesh objects and skeletons, for example, to reflect a character's new appearance as the cartoon progresses.

Similarly, the server 110 can notify the workstation 120 to discard cached mesh objects and skeletons that will no longer be needed, for example, if a cartoon character will no long appear in future episodes or the character's appearances change. Alternatively, the workstation 120 can automatically discard cached components after a period of inactivity with regards to watching the cartoon episodes.

In one embodiment, the server 110 maintains a list of paid subscribers. The subscribers can log into the server 110 with a username/password pair to access a latest episode. The server 110 can cause the animation description, voice tracks, and sound tracks associated with a latest episode to be streamed to the user 122 at the workstation 120.

In another embodiment, the server 110 can periodically transmit the animation description, voice tracks, and sound tracks associated with a latest episode to paid subscribers, for example, via email. In another embodiment, the server 110 can periodically transmit notifications to the subscribers that a new episode is available. For example, the notifications can be transmitted via email, automated phone calls, short message service (SMS), or other communication channels. The subscribers can then access the server 100 to receive the new episode.

In another embodiment, the server 110 can stream or transmit a free teaser or preview episode to non-subscribers. The non-subscribers are then prompted to pay valuable consideration to become subscribers and view subsequent episodes.

In another embodiment, the server 110 can maintain a list of non-paying subscribers, who do not pay valuable consideration. In this embodiment, the episodes can include advertisements from paid advertisers. It will be appreciated that the server 110 can provide two versions of each episode: an advertising-free version for paid subscribers and an advertising version for non-paying subscribers.

In another embodiment, the server 110 can provide the episodes to certain network carriers, such as ISPs, for free viewing by the carrier's users. This allows carriers a competitive edge against other carriers in building a user base.

In another embodiment, the server 110 can stream the animation descriptions, voice tracks, and sound tracks associated with a latest episode at a specific time. This can result in efficient usage of network resources by utilizing various network broadcast protocols.

It will be appreciated that the system can be based on a wireless network. In this example, the workstation 120 can be a cell phone or another portable wireless device. The user 122 can receive and view episodes over a wireless cellular network.

In one embodiment, an advertisement can be a 3D advertisement displayed during playback of the episode. Alternatively, the 3D advertisement can be displayed before or after the episode. The 3D advertisement can be transmitted or streamed by the server.

In one embodiment, an advertisement can be a texture to be painted on one or more 3D objects within the cartoon. For example there could be a sponsor area in avatar clothing. The texture can be streamed during episode playback and changed by the server at any time.

In one embodiment, the user can upload his avatar to the server, which will then include the avatar in the episode as a character within the episode.

FIG. 2 illustrates an example workstation for displaying 3D objects to a user. The workstation 200 can provide a user interface to a user 202. In one example, the workstation 200 can be configured to receive 3D object components from a server or a data store over a network.

The workstation 200 can be a computing device such as a server, a personal computer, desktop, laptop, a personal digital assistant (PDA) or other computing device. The workstation 200 is accessible to the user 202 and provides a computing platform for various applications.

The workstation 200 can include a display 204. The display 204 can be physical equipment that displays viewable images and text generated by the workstation 200. For example, the display 204 can be a cathode ray tube or a flat panel display such as a TFT LCD. The display 204 includes a display surface, circuitry to generate a picture from electronic signals sent by the workstation 200, and an enclosure or case. The display 204 can interface with an input/output interface 210, which translate data from the workstation 200 to signals for the display 204.

The workstation 200 may include one or more output devices 206. The output device 206 can be hardware used to communicate outputs to the user. For example, the output device 206 can include speakers and printers, in addition to the display 204 discussed above.

The workstation 200 may include one or more input devices 208. The input device 208 can be any computer hardware used to translate inputs received from the user 202 into data usable by the workstation 200. The input device 208 can be keyboards, mouse pointer devices, microphones, scanners, video and digital cameras, etc.

The workstation 200 includes an input/output interface 210. The input/output interface 210 can include logic and physical ports used to connect and control peripheral devices, such as output devices 206 and input devices 208. For example, the input/output interface 210 can allow input and output devices 206 and 208 to be connected to the workstation 200.

The workstation 200 includes a network interface 212. The network interface 212 includes logic and physical ports used to connect to one or more networks. For example, the network interface 212 can accept a physical network connection and interface between the network and the workstation by translating communications between the two. Example networks can include Ethernet, the Internet, or other physical network infrastructure. Alternatively, the network interface 212 can be configured to interface with a wireless network. Alternatively, the workstation 200 can include multiple network interfaces for interfacing with multiple networks.

The workstation 200 communicates with a network 214 via the network interface 212. The network 214 can be any network configured to carry digital information. For example, the network 214 can be an Ethernet network, the Internet, a wireless network, a cellular data network, or any Local Area Network or Wide Area Network.

The workstation 200 includes a central processing unit (CPU) 218. The CPU 216 can be an integrated circuit configured for mass-production and suited for a variety of computing applications. The CPU 216 can be installed on a motherboard within the workstation 200 and control other workstation components. The CPU 216 can communicate with the other workstation components via a bus, a physical interchange, or other communication channel.

The workstation 200 includes a memory 218. The memory 218 can include volatile and non-volatile memory accessible to the CPU 216. The memory can be random access and store data required by the CPU 216 to execute installed applications. In an alternative, the CPU 216 can include on-board cache memory for faster performance.

The workstation 200 includes mass storage 220. The mass storage 220 can be volatile or non-volatile storage configured to store large amounts of data. The mass storage 220 can be accessible to the CPU 216 via a bus, a physical interchange, or other communication channel. For example, the mass storage 220 can be a hard drive, a RAID array, flash memory, CD-ROMs, DVDs, HD-DVD or Blu-Ray mediums.

The workstation 200 can include a 3D engine 222. The 3D engine 222 can be configured to render a sequence for display from a 3D object, as discussed above. The 3D object can be received as a mesh object, a skeleton, and an animation description.

The 3D engine 222 can be a Flash-based engine written in Action Script 3.0. It requires a Flash 10 player. It could run in a browser as a Flash application and standalone as AIR application. It can be based on SwiftGL 3D Flash graphics library. It supports skeletal animation, scene based and model based depth sorting.

FIG. 3 illustrates an example server for distributing 3D objects over a network. A server 300 is configured to distribute 3D object components over a network, as discussed above. For example, the server 300 can be a server configured to communicate over a plurality of networks. Alternatively, the server 300 can be any computing device.

The server 300 includes a display 302. The display 302 can be equipment that displays viewable images, graphics, and text generated by the server 300 to a user. For example, the display 302 can be a cathode ray tube or a flat panel display such as a TFT LCD. The display 302 includes a display surface, circuitry to generate a viewable picture from electronic signals sent by the server 300, and an enclosure or case. The display 302 can interface with an input/output interface 308, which converts data from a central processor unit 312 to a format compatible with the display 302.

The server 300 includes one or more output devices 304. The output device 304 can be any hardware used to communicate outputs to the user. For example, the output device 304 can be audio speakers and printers or other devices for providing output.

The server 300 includes one or more input devices 306. The input device 306 can be any computer hardware used to receive inputs from the user. The input device 306 can include keyboards, mouse pointer devices, microphones, scanners, video and digital cameras, etc.

The server 300 includes an input/output interface 308. The input/output interface 308 can include logic and physical ports used to connect and control peripheral devices, such as output devices 304 and input devices 306. For example, the input/output interface 308 can allow input and output devices 304 and 306 to communicate with the server 300.

The server 300 includes a network interface 310. The network interface 310 includes logic and physical ports used to connect to one or more networks. For example, the network interface 310 can accept a physical network connection and interface between the network and the workstation by translating communications between the two. Example networks can include Ethernet, the Internet, or other physical network infrastructure. Alternatively, the network interface 310 can be configured to interface with wireless network. Alternatively, the server 300 can include multiple network interfaces for interfacing with multiple networks.

The server 300 includes a central processing unit (CPU) 312. The CPU 312 can be an integrated circuit configured for mass-production and suited for a variety of computing applications. The CPU 312 can sit on a motherboard within the server 300 and control other workstation components. The CPU 312 can communicate with the other workstation components via a bus, a physical interchange, or other communication channel.

The server 300 includes memory 314. The memory 314 can include volatile and non-volatile memory accessible to the CPU 312. The memory can be random access and provide fast access for graphics-related or other calculations. In one embodiment, the CPU 312 can include on-board cache memory for faster performance.

The server 300 includes mass storage 316. The mass storage 316 can be volatile or non-volatile storage configured to store large amounts of data. The mass storage 316 can be accessible to the CPU 312 via a bus, a physical interchange, or other communication channel. For example, the mass storage 316 can be a hard drive, a RAID array, flash memory, CD-ROMs, DVDs, HD-DVD or Blu-Ray mediums.

The server 300 communicates with a network 318 via the network interface 310. The network 318 can be as discussed. The server 300 can communicate with a mobile device over the cellular network 318.

Alternatively, the network interface 310 can communicate over any network configured to carry digital information. For example, the network interface 310 can communicate over an Ethernet network, the Internet, a wireless network, a cellular data network, or any Local Area Network or Wide Area Network.

The server 300 can include 3D objects 320 stored in the memory 314. For example, the 3D objects 320 can be stored as mesh objects, skeletons, and animation descriptions, as discussed above. The 3D objects 320 can be created by a designer on a workstation, as discussed above. Each 3D object can represent an avatar in a virtual world.

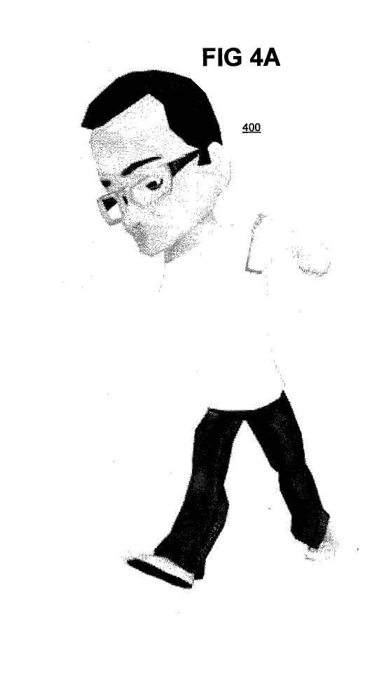

FIG. 4A illustrates an example 3D object 400 rendered into an avatar in a virtual world. For example, the 3D object can be rendered from a 3D object including a mesh object, a skeleton, and an animation sequence. It will be appreciated the rendered 3D object 400 can be animated by the animation sequence. As illustrated, the rendered 3D object 400 can be an avatar in a virtual world. The rendering can be performed at a workstation as illustrated above.

FIG. 4B illustrates an example data structure 450 for storing a 3D object. For example, the data structure can be defined as an Extended Mark-up Language (XML). The data structure can include a data section. The data section can define a skeleton, a mesh, and materials. The skeleton section can define each bone with a local translation, vertex indices, vertices, and weights. The mesh section can define vertices and indices. The material section can define textures and UV coordinates of each texture layer.

The data structure can include a frames section. The frames section can include animation descriptions in the form of frames and keys, which specify how the 3D object will be distorted during rendering.

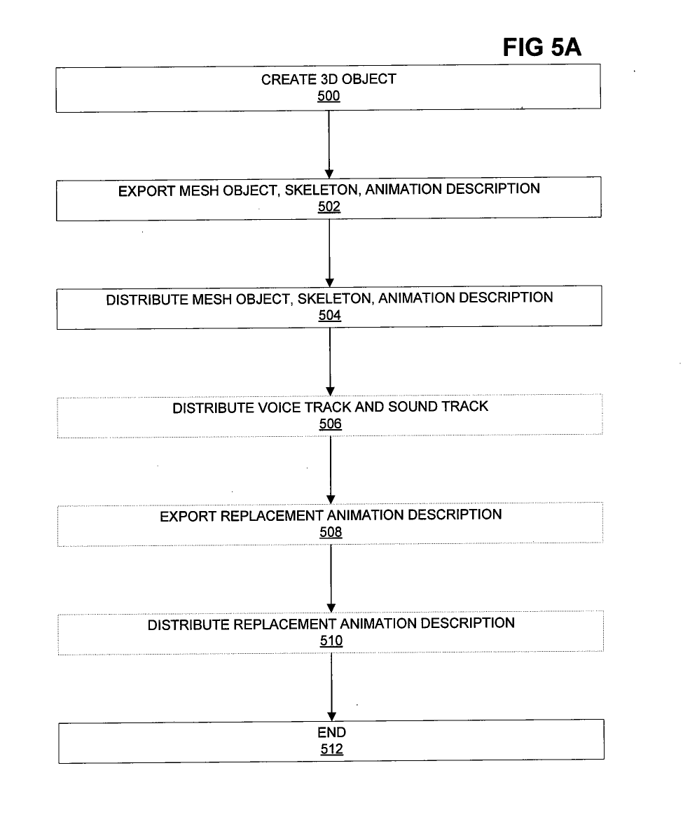

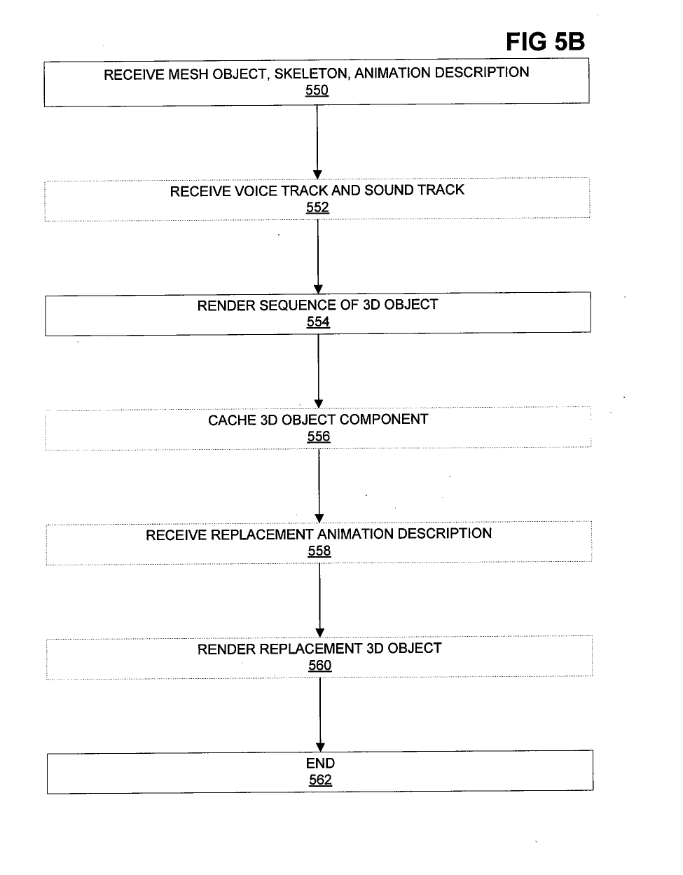

FIG. 5A illustrates an example procedure to create a 3D object. The 3D object can be an animated avatar for display in a virtual world and thus intended for distribution to a large number of clients for rendering. The procedure can execute on a designer's workstation, as illustrated, to create the 3D object.

In 500, the workstation creates a 3D object responsive to designer inputs. For example, the designer can utilize a graphical user interface to specify characteristics of the 3D object. As discussed above, the 3D object can be stored as a mesh object, a skeleton, and an animation sequence, together the 3D object components. The 3D object can be created, for example, with applications such as XSI, Maya, Blender, and 3D Studio Max.

In 502, the 3D object components can be exported to storage. For example, the mesh object and the skeleton can be stored in a first file. The animation description can be stored in a second file. This allows a mesh object and a skeleton of a 3D object to be reused with different animation descriptions, as discussed above. In one example, the animation description can be streamed over a network to a client as needed.

In 504, the 3D object components are distributed to one or more clients. For example, the 3D object components can be distributed by a data store or a server over a network, as discussed above. In one embodiment, the mesh object and skeleton of each animated character is cached by the clients, and subsequent animation descriptions are streamed to the client.

In 506, the workstation can create voice tracks and sound tracks for distribution along with the 3D object components. For example, the 3D object can be used in an animated cartoon episode. Each animated character in the episode will be associated with a voice track. In addition, the episode will be associated with a sound track.

In 508, the workstation optionally exports a replacement animation description. For example, the replacement animation description can be created by a process similar to 500, but working with an existing mesh object and skeleton. This streamlines the design process by reusing existing components for the 3D object. Once the replacement animation description is crated, it is exported similar to the process in 502.

In 510, the workstation optionally distributes the replacement animation description, similar to 504. In addition, the server can also export and distribute replacement voice tracks and sound tracks, similar to 506. This creates an easy process to provide periodic cartoon episodes with low bandwidth requirements.

In 512, the workstation can exit the procedure.

FIG. 5B illustrates an example procedure to display a 3D object at a terminal. For example, the procedure can execute at a client workstation. The workstation can be a computing device configured to provide a user interface between a user and a virtual world, as illustrated above.

In 550, the workstation receives 3D object components, such as the mesh object, the skeleton, and the animation description. As discussed above, a 3D object can be created by a designer and distributed by a data store. The 3D object is saved and distributed in separate components to improve performance and cachability.

In 552, the workstation optionally receives a voice track and a sound track. As discussed above, the 3D object can represent an animated character within a cartoon episode. In this example, the 3D object can be associated with a voice track and the episode can be associated with a sound track.

In 554, the workstation renders an animation sequence of the 3D object. For example, the sequence can be a sequence of 2D images that provides an illusion of movement by the 3D object. The 3D object can be represented by the skeleton and the mesh object, while animation of the 3D object is defined by the animation description.

In 556, the workstation optionally caches one or more 3D object components. As discussed above, the 3D objects can be reused with different animation descriptions, voice tracks, and sound tracks. Thus, the mesh object and the skeleton can be cached in a memory accessible to the workstation.

In 558, the workstation optionally receives a replacement animation description. Once the 3D object render has been executed in 554, a subsequent render can be performed with a replacement animation description. For example, the 3D object can be a character in a cartoon episode. The first render in 554 can be a first episode of the cartoon. A replacement animation description can define a subsequent episode. The replacement animation description can be received over a network from a data store. In one embodiment, the replacement animation description can be streamed from the data store.

In 560, the workstation optionally renders a replacement 3D object into a replacement sequence. The replacement sequence can be a subsequent episode of the cartoon, as discussed above. In addition, the workstation can receive replacement voice tracks and sound tracks for the cartoon episode.

In 562, the workstation exits the procedure.

As discussed above, one example embodiment of the present invention is a method for displaying 3D objects. The method includes creating a 3D object for rendering. The method includes exporting the 3D object as a mesh object, a skeleton, and an animation description. The method includes distributing the mesh object, the skeleton, and the animation description as at least two separate components. The method includes combining the mesh object, the skeleton, and the animation description at a user workstation for rendering a sequence defined by the 3D object. The method includes caching at least one of: the mesh object, the skeleton, and the animation description for use with a replacement 3D object. The method includes distributing a replacement animation description, wherein the mesh object, the skeleton, and the replacement animation description are combined for rendering into a replacement sequence defined by the replacement 3D object. The method includes distributing a voice track and a sound track for playback substantially simultaneously with the sequence. The mesh object and the skeleton can be exported into a first file and the animation description can be exported into a second file. The 3D object can be created by a designer and the sequence is rendered for a user. The rendering can be executed by a Flash-based 3D engine executing on the user workstation.

Another example embodiment of the present invention is a client system for displaying 3D objects. The system includes a network interface in communication with a server. The system includes an accessible storage medium. The system includes a processor in communication with the network interface and the accessible storage medium. The processor can be configured to receive a mesh object, a skeleton, and an animation description over the network interface as at least two separate components, wherein the mesh object, the skeleton, and the animation description define a 3D object. The processor can be configured to combine the mesh object, the skeleton, and the animation description for rendering a sequence defined by the 3D object. The processor can be configured to cache at least one of: the mesh object, the skeleton, and the animation description in the accessible storage medium for use with a replacement 3D object. The processor can be configured to receive a replacement animation description, wherein the mesh object, the skeleton, and the replacement animation description are combined for rendering into a replacement sequence defined by the replacement 3D object. The processor can be configured to receive a voice track and a sound track for playback substantially simultaneously with the sequence. The mesh object and the skeleton can be exported into a first file and the animation description can be exported into a second file. The 3D object can be created by a designer and the sequence is rendered for a user by the system. The rendering can be executed by a Flash-based 3D engine executing on the user workstation.

Another example embodiment of the present invention is a computer-readable medium including instructions adapted to execute a method for displaying 3D objects. The method includes creating a 3D object for rendering. The method includes exporting the 3D object as a mesh object, a skeleton, and an animation description. The method includes distributing the mesh object, the skeleton, and the animation description as at least two separate components. The method includes combining the mesh object, the skeleton, and the animation description at a user workstation for rendering a sequence defined by the 3D object. The method includes caching at least one of: the mesh object, the skeleton, and the animation description for use with a replacement 3D object. The method includes distributing a replacement animation description, wherein the mesh object, the skeleton, and the replacement animation description are combined for rendering into a replacement sequence defined by the replacement 3D object. The method includes distributing a voice track and a sound track for playback substantially simultaneously with the sequence. The mesh object and the skeleton can be exported into a first file and the animation description can be exported into a second file. The 3D object can be created by a designer and the sequence is rendered for a user. The rendering can be executed by a Flash-based 3D engine executing on the user workstation.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A method for displaying 3D objects, comprising:
creating a 3D object for rendering;
exporting the 3D object as a mesh object, a skeleton, and an animation description;
distributing the mesh object, the skeleton, and the animation description as at least two separate components; and
combining the mesh object, the skeleton, and the animation description at a user workstation for rendering a sequence defined by the 3D object.

2. The method of claim 1, further comprising:
caching at least one of: the mesh object, the skeleton, and the animation description for use with a replacement 3D object.

3. The method of claim 2, further comprising:
distributing a replacement animation description, wherein the mesh object, the skeleton, and the replacement animation description are combined for rendering into a replacement sequence defined by the replacement 3D object.

4. The method of claim 2, further comprising:
distributing a voice track and a sound track for playback substantially simultaneously with the sequence.

5. The method of claim 1, wherein the mesh object and the skeleton are exported into a first file and the animation description are exported into a second file.

6. The method of claim 1, wherein the 3D object is created by a designer and the sequence is rendered for a user.

7. The method of claim 6, wherein the rendering is executed by a Flash-based 3D engine executing on the user workstation.

8. A client system for displaying 3D objects, comprising:
a network interface in communication with a server;
an accessible storage medium; and
a processor in communication with the network interface and the accessible storage medium, the processor configured to
receive a mesh object, a skeleton, and an animation description over the network interface as at least two separate components, wherein the mesh object, the skeleton, and the animation description define a 3D object, and
combine the mesh object, the skeleton, and the animation description for rendering a sequence defined by the 3D object.

9. The system of claim 8, the processor further configured to,
cache at least one of: the mesh object, the skeleton, and the animation description in the accessible storage medium for use with a replacement 3D object.

10. The system of claim 9, the processor further configured to,
receive a replacement animation description, wherein the mesh object, the skeleton, and the replacement animation description are combined for rendering into a replacement sequence defined by the replacement 3D object.

11. The system of claim 9, the processor further configured to,
receive a voice track and a sound track for playback substantially simultaneously with the sequence.

12. The system of claim 8, wherein the mesh object and the skeleton are exported into a first file and the animation description are exported into a second file.

13. The system of claim 8, wherein the 3D object is created by a designer and the sequence is rendered for a user by the system.

14. The system of claim 13, wherein the rendering is executed by a Flash-based 3D engine executing on the user workstation.

15. A computer-readable medium including instructions adapted to execute a method for displaying 3D objects, the method comprising:
creating a 3D object for rendering;
exporting the 3D object as a mesh object, a skeleton, and an animation description;
distributing the mesh object, the skeleton, and the animation description as at least two separate components; and
combining the mesh object, the skeleton, and the animation description at a user workstation for rendering a sequence defined by the 3D object.

16. The medium of claim 15, the method further comprising:
caching at least one of: the mesh object, the skeleton, and the animation description for use with a replacement 3D object.

17. The medium of claim 16, the method further comprising:
distributing a replacement animation description, wherein the mesh object, the skeleton, and the replacement animation description are combined for rendering into a replacement sequence defined by the replacement 3D object.

18. The medium of claim 16, the method further comprising:
distributing a voice track and a sound track for playback substantially simultaneously with the sequence.

19. The medium of claim 15, wherein the mesh object and the skeleton are exported into a first file and the animation description are exported into a second file.

20. The medium of claim 15, wherein the 3D object is created by a designer and the sequence is rendered for a user and the rendering is executed by a Flash-based 3D engine executing on the user workstation.

21. A method of distributing multimedia content, comprising:
retrieving a first 3D object for distribution, wherein the first 3D object includes a mesh object, a skeleton, and a first animation description defining a first animation sequence of a three-dimensional object;
distributing the mesh object, the skeleton, and the first animation description over a network to a client for rendering, wherein the client caches the mesh object and the skeleton;
retrieving a second 3D object for distribution, wherein the second 3D object includes the mesh object, the skeleton, and a second animation description defining a second animation sequence of the three-dimensional object; and
distributing the second animation description over the network to the client for rendering, wherein the client retrieves the cached mesh object and the cached skeleton.

22. The method of claim 21, wherein the first and second 3D objects sequences define a character within cartoon episodes.

23. The method of claim 22, further comprising:
distributing a first voice track to the client for play back substantially simultaneously with rendering the first 3D object; and
distributing a second voice track to the client for play back substantially simultaneously with rendering the second 3D object.

24. The method of claim 21, wherein the client becomes a subscriber by paying valuable consideration to receive the second animation description.

25. The method of claim 21, wherein the first and second animation descriptions are streamed over the network to the client responsive to a client request.

26. The method of claim 21, further comprising:
distributing an advertisement to be displayed with the second 3D object.
